(19) United States
(12) Patent Application Publication
(10) Pub. No.: US 2020/0334735 A1
(43) Pub. Date: Oct. 22, 2020

(54) DIGITAL ONBOARDING AND REAL-TIME DISPERSION PLATFORM

(71) Applicant: BANK OF AMERICA CORPORATION, Charlotte, NC (US)

(72) Inventors: John E. Scully, Chicago, IL (US); Kelly Elizabeth Firment, West Chester, PA (US); Jarett Steven Isralow, Charlotte, NC (US); Robert A. Pascal, Marblehead, MA (US); Diana Stamper Shaffer, Charlotte, NC (US)

(73) Assignee: BANK OF AMERICA CORPORATION, Charlotte, NC (US)

(21) Appl. No.: 16/821,620

(22) Filed: Mar. 17, 2020

Related U.S. Application Data
(60) Provisional application No. 62/819,993, filed on Mar. 18, 2019.

(51) Int. Cl. G06Q 30/06

(52) U.S. Cl. CPC G06Q 30/0631

(57) ABSTRACT

Embodiments of the invention are directed to a system, method, or computer program product for digital onboarding across platforms, intelligent search engine text modification, and real-time resource distribution and cross channel application processing. In this way, the platform provides a centralized user interaction database with logically controlled dynamic presentations of stored data and confidence levels across multiple communication channels within a single entity.

### CROSS-REFERENCE TO RELATED APPLICATIONS

This application claims priority to U.S. Provisional Patent Application No. 62/819,993, filed Mar. 18, 2019 titled Digital Onboarding and Real-Time Dispersion Platform, the contents of which are hereby incorporated by reference in its entirety.

### BACKGROUND

With advancements in machine and product development, more and more machines and products are being implemented by businesses. The expansion of small businesses within the internet and product development continues to grow. Managing the requirements of a business, especially a small business, continues to require communications with third party entities for management of the business.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the invention are directed to a system, method, or computer program product for digital onboarding across platforms, intelligent search engine text modification, and real-time resource distribution and cross channel application processing.

In some embodiments, the invention provides for digital onboarding across platforms. The invention provides an onboarding platform for user experience tailoring. Using the onboarding platform, the entity may be able to provide a tailored user experience that curated suggestions to provide better user experience. Thus providing an automated and integrated onboarding experience for seamless user onboarding.

Upon initiation of communication with a user, an associate may ask questions for onboarding the user for a product or service at the entity. The system may generate scores based on the questions and answers received. The scoring metrics are generated and deployed for identification of the user's potential needs in products that the entity provides. As such, using the scores, the system identifies products/services the user may be interested in addition to the product the user is currently on boarded. For example, if a user opens a checking account, but has asked a lot of small business questions, the system processes the product the user is opening and the user comments to generate a score. The algorithm may then process the score and provide products associated with a small business since the score indicated the user interest in small business based on the on boarding questions. As such, the system may identify products such as two credit cards for the user's business and the type of cards that may match the user's needs. As such, upon identification that the user is a business owner, the system may store that information and tailor future communications and products to the user associated with the user's business.

In some embodiments, the onboarding platform may include a centralized database used for user experience tailoring. The centralized database may store all the entity products, triggers for all of the products, score ranges for each of the products, and the like. As such, upon identification of a score for a user, the databased may provide a dynamic real-time presentment of options or adjustments for the user based on the user communications with the entity.

The system may go further than identification of the user being a business owner. The system may further identify the specific business and specific needs for that business. For example, a computer store owner may have different business needs than a dentist office. The platform may include an artificial intelligent engine that may process attributes about the business, such as the type of business, size, receivables, employees, and the like to identify similar attributes of those business and provide user with similar options and adjustments.

In some embodiments, the platform stores user information for seamless and simplified conversion of new user from previous entities based on receiving user credentials.

In some embodiments, the invention provides an intelligent search engine text modifier. In this way, the invention includes an intelligent engine associated with a platform. The intelligent engine may modify text on an entity website based on the user viewing the webpage and/or the hits generated on a search engine. In this way, the engine may modify the words on a website based on the specific user. In this way, the engine identifies trending search terms for the user based on search engine results for the user. The system modifies a website to translate the website to include terms. Utilizing current application program interfaces (API) to modify and dynamically change websites for targeted audience review.

In some embodiments, the invention provides for real-time resource distribution and cross channel application processing. In this way, the invention includes a centralized cross channel database for storing all data inputted by a user for an application. That way, upon resuming an application at one or more other channels, the user data is formatted and presented to the user on the separate channel. Furthermore, the centralized database may further calculate a confidence score of a user based on the information obtained within the database from user communications, resources, accounts, and the like. The confidence scoring allows the system to confirm and immediately process access to resources. As such, upon application for resources, such as a loan or the like, the user may have instant access to the resources upon applying, based on the user confidence score.

Embodiments of the invention relate to systems, methods, and computer program products for digital onboarding across platforms, intelligent search engine text modification, and real-time resource distribution and cross channel application processing.

Embodiments of the invention relate to systems, methods, and computer program products for digital onboarding and real-time dispersion, the invention comprising: creating a communicable linkage between communication channels across an entity for communication identification; identifying a user communication via one of the communication channel; onboarding the user digitally across platform, where onboarding the user digitally across the platform comprises storing application process data associated with user communication; modifying text within a website based on onboarding the user digitally across the platform; generating a confidence level analysis that the stored application processing data associated with the user communication is current; and providing cross channel application processing with population of application processing data associated with the user communication at a different channel.

In some embodiments, onboarding the user digitally across platforms further comprises performing onboarding platform metrics on the user communication to identify products and services associated with the user.

In some embodiments, the invention further comprises generating a compatibility score correspond to the products and services provided, wherein the compatibility score is calculated based on a match between the products and services provided and terms the user utilized during the communication providing a predictive user interested in the products and services for future user implementation.

In some embodiments, the invention further comprises presenting an associate communicating with the user with a real-time presentment of options or adjustments to the user for the products and services provided and the score associated therewith for presentation to the user during communication with the user.

In some embodiments, modifying text within a website based on onboarding the user digitally across the platform further comprises modify words on the website for the user based on engine identified trending search terms for the user, wherein the modifying is performed via integration within a current application program interfaces to dynamically change the websites for the user.

In some embodiments, the invention further comprises triggering a real-time distribution of resources upon a future application filing based on the stored application process data and the confidence level of the stored application process data, such that upon completion of the application and the application filing the user receive resources in real-time without additional processing delays.

In some embodiments, modifying text within a website based on onboarding the user digitally across the platform further comprises tailoring the text within the website for the user.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a digital onboarding platform integration system environment, in accordance with one embodiment of the present invention;

FIG. 2 provides a communication linkage generation system environment, in accordance with one embodiment of the present invention;

FIG. 3 provides an onboarding system architecture environment, in accordance with one embodiment of the present invention;

FIG. 4 provides a high level process flow illustrating digital onboarding across platforms process, in accordance with one embodiment of the present invention;

FIG. 5 provides a process map illustrating onboarding processing for user business, in accordance with one embodiment of the present invention;

FIG. 6 provides a high level process flow illustrating intelligent search text modification, in accordance with one embodiment of the present invention; and

FIG. 7 provides a high level process flow illustrating real-time resource distribution and cross channel application processing, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

A “user” as used herein may refer to any entity or individual associated with a business. In some embodiments, the user may be the business. In some embodiments, the user may be an individual associated with the business. In some embodiments, the business may be a small business, such as one with under 500 employees. In yet other embodiments, the business may be a larger business, such as one with 500 or more employees. In some embodiments, identities of an individual may include online handles, usernames, aliases, family names, maiden names, nicknames, or the like. Furthermore, as used herein the term “user device” or “mobile device” may refer to mobile phones, personal computing devices, tablet computers, wearable devices, and/or any portable electronic device capable of receiving and/or storing data therein associated with the business.

As used herein, a “user interface” generally includes a plurality of interface devices and/or software that allow a customer to input commands and data to direct the processing device to execute instructions. For example, the user interface may include a graphical user interface (GUI) or an interface to input computer-executable instructions that direct the processing device to carry out specific functions. Input and output devices may include a display, mouse, keyboard, button, touchpad, touch screen, microphone, speaker, LED, light, joystick, switch, buzzer, bell, and/or other user input/output device for communicating with one or more users.

A “transaction” or “resource distribution” refers to any communication between a user and the financial institution or other entity monitoring the user's activities to transfer funds for the purchasing or selling of a product. A transaction may refer to a purchase of goods or services, a return of goods or services, a payment transaction, a credit transaction, or other interaction involving a user's account. In the context of a financial institution, a transaction may refer to one or more of: a sale of goods and/or services, initiating an automated teller machine (ATM) or online banking session, an account balance inquiry, a rewards transfer, an account money transfer or withdrawal, opening a bank application on a user's computer or mobile device, a user accessing their e-wallet, or any other interaction involving the user and/or the user's device that is detectable by the financial institution. A transaction may include one or more of the following: renting, selling, and/or leasing goods and/or services (e.g., groceries, stamps, tickets, DVDs, vending machine items, and the like); making payments to creditors (e.g., paying monthly bills; paying federal, state, and/or local taxes; and the like); sending remittances; loading money onto stored value cards (SVCs) and/or prepaid cards; donating to charities; and/or the like.

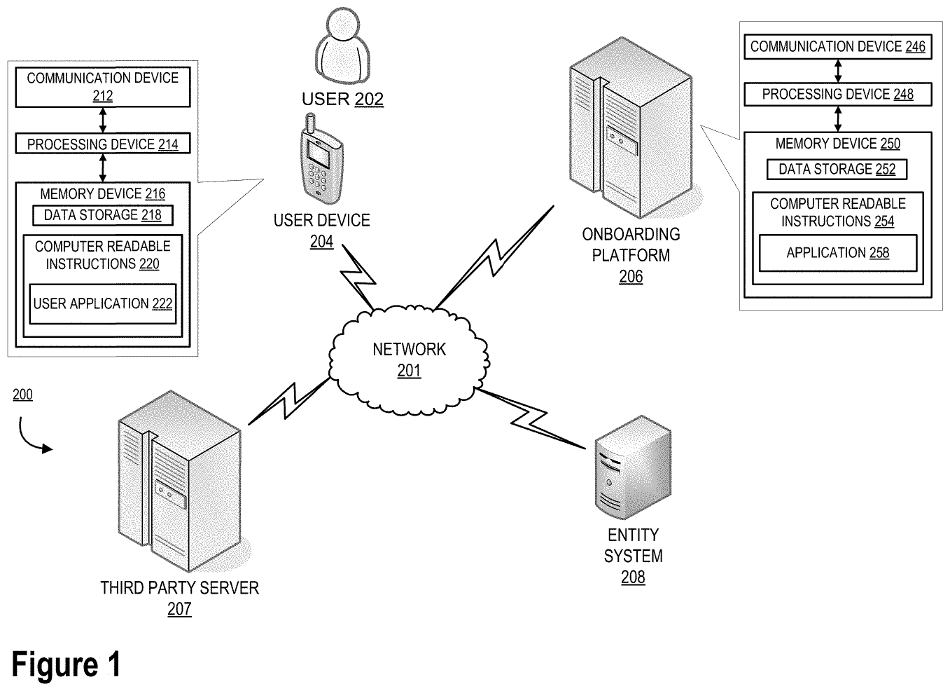

FIG. 1 illustrates a digital onboarding platform integration system environment 200, in accordance with one embodiment of the present invention. FIG. 1 provides the system environment 200 for which the distributive network system with specialized data feeds associated with resource distribution. FIG. 1 provides a unique system that includes specialized servers and system communicably linked across a distributive network of nodes required to perform the functions of digital onboarding across platforms, intelligent search engine text modification, and real-time resource distribution and cross channel application processing.

As illustrated in FIG. 1, the entity system 208 is operatively coupled, via a network 201 to the user device 204, third party servers 207, and to the onboarding platform 206. In this way, the entity system 208 can send information to and receive information from the user device 204, third party servers 207, and the onboarding platform 206. FIG. 1 illustrates only one example of an embodiment of the system environment 200, and it will be appreciated that in other embodiments one or more of the systems, devices, or servers may be combined into a single system, device, or server, or be made up of multiple systems, devices, or servers.

The network 201 may be a system specific distributive network receiving and distributing specific network feeds and identifying specific network associated triggers. The network 201 may also be a global area network (GAN), such as the Internet, a wide area network (WAN), a local area network (LAN), or any other type of network or combination of networks. The network 201 may provide for wireline, wireless, or a combination wireline and wireless communication between devices on the network 201.

In some embodiments, the user 202 is an individual that has one or more user devices 204 and is in communication with an entity. In some embodiments, the user 202 has a user device, such as a mobile phone, tablet, computer, or the like. FIG. 1 also illustrates a user device 204. The user device 204 may be, for example, a desktop personal computer, business computer, business system, business server, business network, a mobile system, such as a cellular phone, smart phone, personal data assistant (PDA), laptop, or the like. The user device 204 generally comprises a communication device 212, a processing device 214, and a memory device 216. The processing device 214 is operatively coupled to the communication device 212 and the memory device 216. The processing device 214 uses the communication device 212 to communicate with the network 201 and other devices on the network 201, such as, but not limited to the onboarding platform 206, the entity system 208, and the third party sever 207. As such, the communication device 212 generally comprises a modem, server, or other device for communicating with other devices on the network 201.

The user device 204 comprises computer-readable instructions 220 and data storage 218 stored in the memory device 216, which in one embodiment includes the computer-readable instructions 220 of a user application 222. In some embodiments, the user application 222 allows a user 202 to send and receive communications with the onboarding platform 206.

As further illustrated in FIG. 1, the onboarding platform 206 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the entity system 208, the third party server 207, and the user device 204. As such, the communication device 246 generally comprises a modem, server, or other device for communicating with other devices on the network 201.

As further illustrated in FIG. 1, the onboarding platform 206 comprises computer-readable instructions 254 stored in the memory device 250, which in one embodiment includes the computer-readable instructions 254 of an application 258. In some embodiments, the memory device 250 includes data storage 252 for storing data related to the system environment 200, but not limited to data created and/or used by the application 258.

In one embodiment of the onboarding platform 206 the memory device 250 stores an application 258. In one embodiment of the invention, the application 258 may associate with applications having computer-executable program code that generate and code a tag for implementation onto a product. Furthermore, the onboarding platform 206, using the processing device 248 codes certain communication functions described herein. In one embodiment, the computer-executable program code of an application associated with the application 258 may also instruct the processing device 248 to perform certain logic, data processing, and data storing functions of the application. The processing device 248 is configured to use the communication device 246 to communicate with and ascertain data from one or more entity system 208, third party servers 207, and/or user device 204.

In the embodiment illustrated in FIG. 1 and described throughout much of this specification, the application 258 may generate and display a dashboard on the user device 204 via a communication channel through the network 201. The communication channel may be closed and secure, such that the application 258 may present sensitive user or business information about resources and the like to the user device 204.

As illustrated in FIG. 1, the third party server 207 is connected to the entity system 208, user device 204, and onboarding platform 206. The third party server 207 has the same or similar components as described above with respect to the user device 204 and the onboarding platform 206. While only one third party server 207 is illustrated in FIG. 1, it is understood that multiple third party servers 207 may make up the system environment 200. The third party server 207 may be associated with one or more third party entities, third party financial institutions, or the like.

As illustrated in FIG. 1, the entity system 208 is connected to the third party server 207, user device 204, and onboarding platform 206. The entity system 208 may be associated with the onboarding platform 206 providing entity. In this way, the entity system may be a financial institution entity system or the like. The entity system 208 has the same or similar components as described above with respect to the user device 204 and the onboarding platform 206. While only one entity system 208 is illustrated in FIG. 1, it is understood that multiple entity system 208 may make up the system environment 200. It is understood that the servers, systems, and devices described herein illustrate one embodiment of the invention. It is further understood that one or more of the servers, systems, and devices can be combined in other embodiments and still function in the same or similar way as the embodiments described herein. The entity system 208 may generally include a processing device communicably coupled to devices as a memory device, output devices, input devices, a network interface, a power source, one or more chips, and the like. The entity system 208 may also include a memory device operatively coupled to the processing device. As used herein, memory may include any computer readable medium configured to store data, code, or other information. The memory device may include volatile memory, such as volatile Random Access Memory (RAM) including a cache area for the temporary storage of data. The memory device may also include non-volatile memory, which can be embedded and/or may be removable. The non-volatile memory may additionally or alternatively include an electrically erasable programmable read-only memory (EEPROM), flash memory or the like.

The memory device may store any of a number of applications or programs which comprise computer-executable instructions/code executed by the processing device to implement the functions of the entity system 208 described herein.

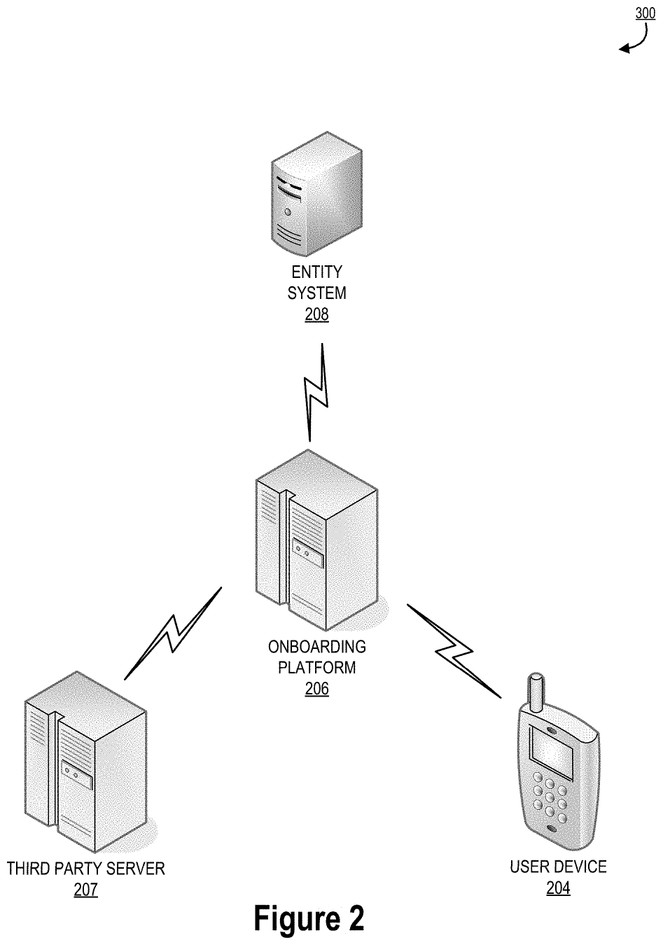

FIG. 2 illustrates a communication linkage generation system environment 300, in accordance with one embodiment of the present invention. As illustrated, the onboarding platform 206 is linked via a private communicable linkage to the third party server 207, the user device 204, and the entity system 208 which supports the onboarding platform 206. The onboarding platform 206 may extract information from a third party server 207, the user device 204, and the entity system 208 related to the user and/or business. This information may be resource information, application information, preferences, current products, potential new product identification, or the like. In this way, the onboarding platform 206 may receive information from the third party server 207. As such, the user may communicate an approval and authorization to the third party server 207 to allow the onboarding platform 206 to extract data from the third party server 207 related to the user. Furthermore, the user via the user device 204 may allow for the onboarding platform 206 to extract data about the user from the user devices. In other embodiments, the user may provide information via user input on the user device to the onboarding platform 206. As illustrated, the entity system 208 associated with the entity providing the onboarding platform 206 may provide information about the user.

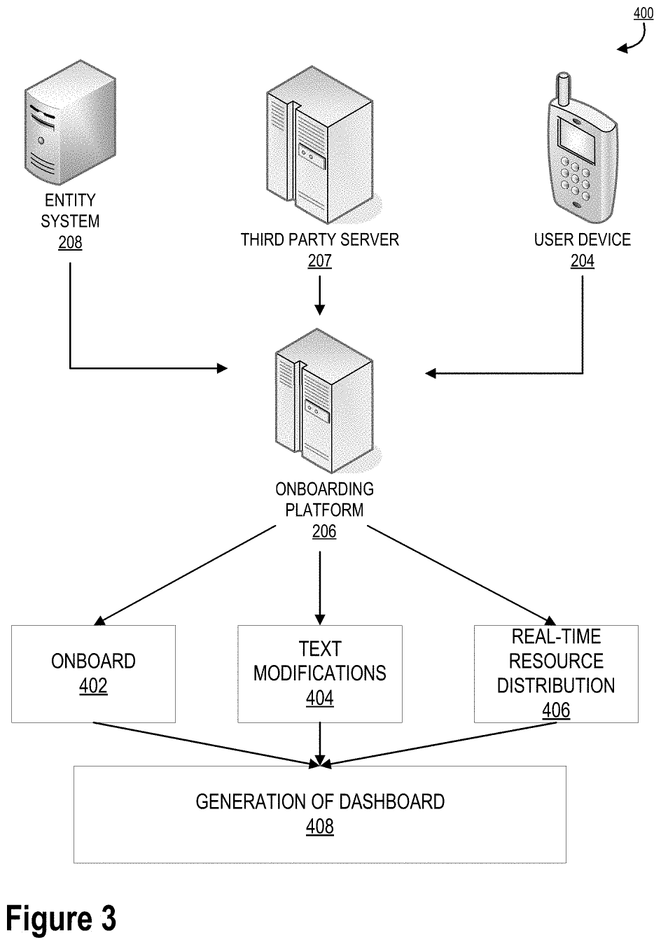

FIG. 3 illustrates an onboarding system architecture environment 400, in accordance with one embodiment of the present invention. As illustrated, the entity system 208, the third party server 207, and the user device 204 may provide the onboarding platform 206 with information in the form of data packets that includes information about the user, user business, and the like. The onboarding platform 206 may receive information about the entity products that the user utilizes. These entity products may be products provided by the entity associated with the onboarding platform 206. In some embodiments, these entity products 402 may include financial institution provided products, such as payments, lending, merchant service history, and the like extracted from the financial institution internal servers, such as the entity system 208.

In some embodiments, the onboarding platform 206 may generate industry analytics. The onboarding platform 206 preforms analytics to the entity system data, the third party server data, the user device data, and data from aggregation services to, in some embodiments, provide a scoring system for the user. In this way, the onboarding platform 206 identifies similar users, the resource management of the user, terms, and industry performance within a geographic area. In addition, the onboarding platform 206 may monitor and provide recommendations for products. As such, the onboarding platform 206 may track trending data, past orders of the user, similar users, and the like.

Utilizing the data received at the onboarding platform 206, the onboarding platform 206 may generate a digital onboarding application process for seamless onboarding of the user across channels, as illustrated in block 402.

Utilizing the data received at the onboarding platform 206, the onboarding platform 206 may perform intelligent text modification to a website for user targeting website generation and distribution, as illustrated in block 404.

Utilizing the data received at the onboarding platform 206, the onboarding platform 206 may perform real-time resource distribution and cross channel application processing, as illustrated in block 406.

Once the onboarding platform 206 receives the data, the onboarding platform 206 may process the data to generate a dashboard, as illustrated in block 408. The dashboard may be provided to the user, an associate of the entity, or the like in order to onboard or perform entity functions.

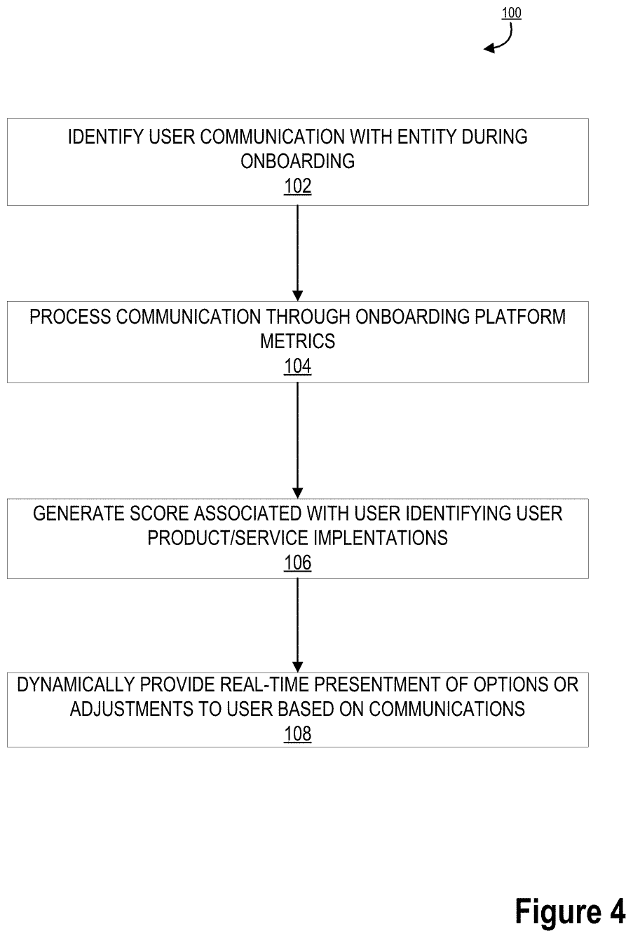

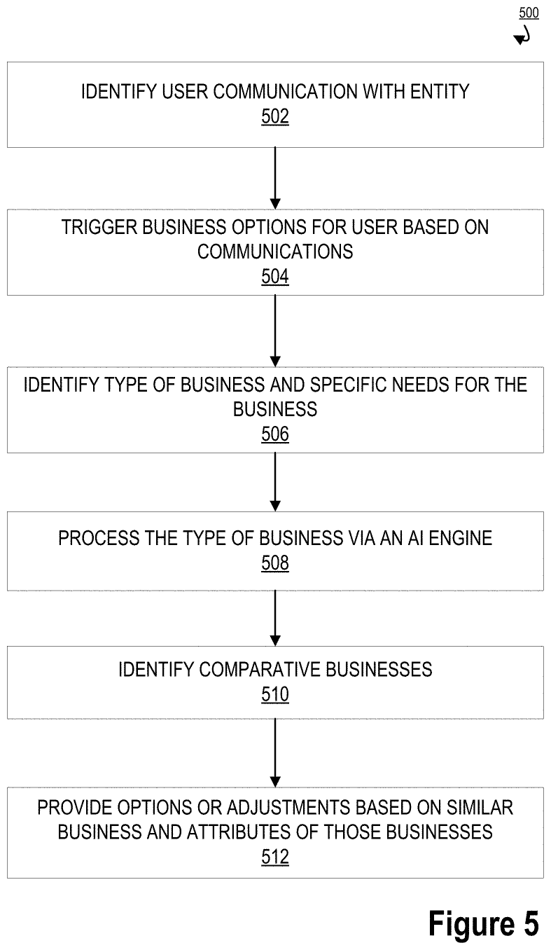

In some embodiments, the invention provides for digital onboarding across platforms, which is further illustrated below with respect to FIG. 4 and FIG. 5. The invention provides an onboarding platform for user experience tailoring. Using the onboarding platform, the entity may be able to provide a tailored user experience that curated suggestions to provide better user experience. Thus providing an automated and integrated onboarding experience for seamless user onboarding.

Upon initiation of communication with a user, an associate may ask questions for onboarding the user for a product or service at the entity. The system may generate scores based on the questions and answers received. The scoring metrics are generated and deployed for identification of the user's potential needs in products that the entity provides. As such, using the scores, the system identifies products/services the user may be interested in addition to the product the user is currently on boarded. For example, if a user opens a checking account, but has asked a lot of small business questions, the system processes the product the user is opening and the user comments to generate a score. The algorithm may then process the score and provide products associated with a small business since the score indicated the user interest in small business based on the on boarding questions. As such, the system may identify products such as two credit cards for the user's business and the type of cards that may match the user's needs. As such, upon identification that the user is a business owner, the system may store that information and tailor future communications and products to the user associated with the user's business.

In some embodiments, the onboarding platform may include a centralized database used for user experience tailoring. The centralized database may store all the entity products, triggers for all of the products, score ranges for each of the products, and the like. As such, upon identification of a score for a user, the databased may provide a dynamic real-time presentment of options or adjustments for the user based on the user communications with the entity.

The system may go further than identification of the user being a business owner. The system may further identify the specific business and specific needs for that business. For example, a computer store owner may have different business needs than a dentist office. The platform may include an artificial intelligent engine that may process attributes about the business, such as the type of business, size, receivables, employees, and the like to identify similar attributes of those business and provide user with similar options and adjustments.

In some embodiments, the platform stores user information for seamless and simplified conversion of new user from previous entities based on receiving user credentials. Furthermore, the system may prepopulate items in applications or the like for seamless user onboarding.

FIG. 4 provides a high level process flow illustrating digital onboarding across platforms process 100, in accordance with one embodiment of the present invention. As illustrated in block 102, the process is initiated by identifying a user communication with an entity during an onboarding process. In this way, a user may be communication with an entity via one of various communication channels, such as in person, on the phone, over the internet, text, or the like. The user may be a current customer of the entity or may be a new customer of the entity. The user may be being on boarded for a product or service provided by the entity.

As illustrated in block 104, the process continues by processing the communications through the platform and performing onboarding platform metrics on the communications. In this way, the system may identify the communications of the user and store the communications. The communications may be analyzed in order to identify one or more products or services the user may be interested in. These may be products or services ancillary to the current product the user is being on boarded. The products or services may be based on the current products of the user or based on comments the user communicates during the communication.

For example, a user may be at a financial institution attempting to open an account. During the communications, the user may indicate that he/she is a small business owner. The system may identify that and provide the user with products associated with the user's specific business and business needs.

As illustrated in block 106, the process 100 continues by generating a score associated with user identifying user products/services for user implementation. The score may be calculated by algorithmic functions based on the terms the user uses during the communication. The generated score then may correspond to products/services of the entity that the user may be interested in based on the communication for future user implementation.

As illustrated in block 108, the process 100 is finalized by dynamically providing real-time presentment of options or adjustments to the user for products/services provided by the entity to the user based on the communications and the score associated therewith.

FIG. 5 provides a process map illustrating onboarding processing for user business 500, in accordance with one embodiment of the present invention. As illustrated in block 502, the process 500 is initiated by identifying a user communication with the entity. The communication is then identified by the onboarding platform and a score is generated for the communication for products and services for the user. During the communication, the onboarding platform identifies the user is associated with a business as a partner, business owner, or the like.

As illustrated in block 504, upon an indication that the user is associated with a business, the system may trigger business options for the user based on the communications. These options may be products, services, plans, or the like that the entity may provide to the user to aid in business management, financial planning, or the like.

Next, as illustrated in block 506, the process 500 continues by identifying a specific type of business associated with the user and the specific needs for that business. As such, the platform may be able to identify specific needs for a specific business size, type, industry, or the like in order to provide a more tailored and streamline solution for the user.

As illustrated in block 508, the process 500 continues by processing the type of business via an artificial intelligence engine associated with the platform. The artificial intelligence engine may examine aspects of the business relative to similarly situated businesses to provide information on how other similarly situated business utilize products or services for implementation. As illustrated in block 510, the artificial intelligence engine may identify comparative businesses for the user for review and comparative analytics.

Finally, as illustrated in block 512, the process 500 is finalized by providing the user with options or adjustments based on the similarly situated business and attributes of those business.

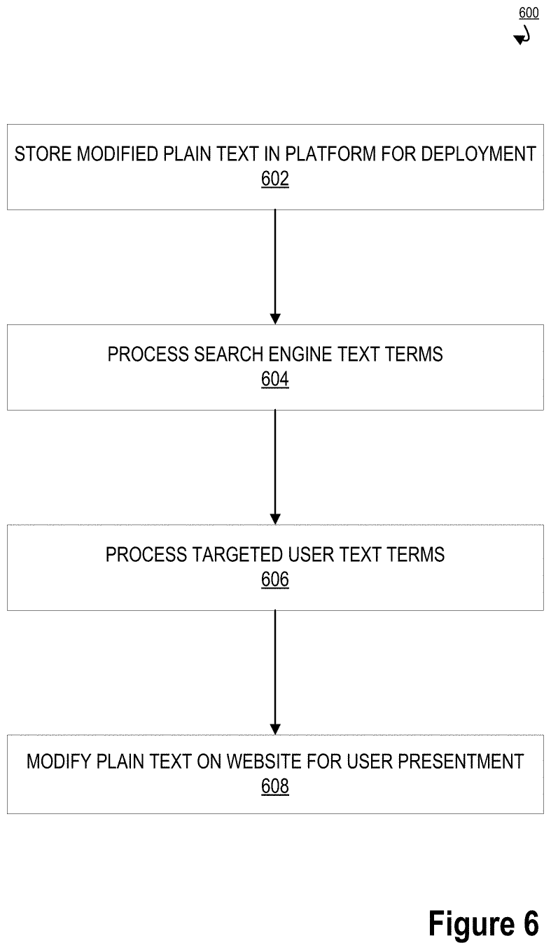

In some embodiments, the invention provides an intelligent search engine text modifier, as illustrated in FIG. 6. In this way, the invention includes an intelligent engine associated with a platform. The intelligent engine may modify text on an entity website based on the user viewing the webpage and/or the hits generated on a search engine. In this way, the engine may modify the words on a website based on the specific user. In this way, the engine identifies trending search terms for the user based on search engine results for the user. The system modifies a website to translate the website to include terms. Utilizing current application program interfaces (API) to modify and dynamically change websites for targeted audience review.

FIG. 6 provides a high level process flow illustrating intelligent search text modification 600, in accordance with one embodiment of the present invention. As illustrated in block 602, the process 600 is initiated by storing modified plain text implementations in the platform for deployment in a website or application. In this way, the system may store multiple plain text terms, key words, or the like that may be displayed on a website associated with the entity based on the user viewing the website. As such, multiple different variations may be available for display on a website for a more targeted approach to website display.

As illustrated in block 604, the process 600 next processes search engine text terms. As such, while the system may display terms for a more tailored user experience, the system may also continuously identify new terms to store based on current search engine trends. Furthermore, the system may process and store targeted user text terms, as illustrated in block 606. In this way, the system may compile text terms from targeted users and search engines to deploy on a website. The system may store the text terms prior to launching various terms onto a website in live display.

Finally, as illustrated in block 608, the process 600 may identify a user attempting to access a webpage and modify via application program interface plain text on the website for presentation to the user. As such, the system provides a modified personalized website for user visualization.

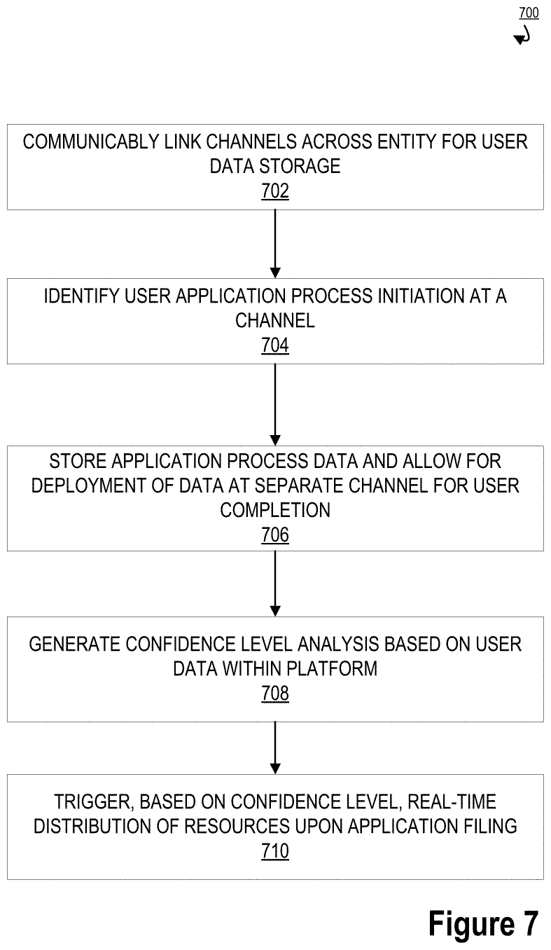

In some embodiments, the invention provides for real-time resource distribution and cross channel application processing, as illustrated in FIG. 7. In this way, the invention includes a centralized cross channel database for storing all data inputted by a user for an application. That way, upon resuming an application at one or more other channels, the user data is formatted and presented to the user on the separate channel. Furthermore, the centralized database may further calculate a confidence score of a user based on the information obtained within the database from user communications, resources, accounts, and the like. The confidence scoring allows the system to confirm and immediately process access to resources. As such, upon application for resources, such as a loan or the like, the user may have instant access to the resources upon applying, based on the user confidence score.

FIG. 7 provides a high level process flow illustrating real-time resource distribution and cross channel application processing 700, in accordance with one embodiment of the present invention. As illustrated in block 702, the process 700 is initiated by generating a communicable link between the channels across an entity for user data storage and communication identification. In this way, the system may interlink all of the various communication channels across the entity for data storage and retrieval across multiple channels.

As illustrated in block 704, the process 700 continues by identifying user application process initiation at a channel. As such, the system may identify that a user is interacting with a channel at the entity for onboarding into one or more products or services via an application process.

Next, as illustrated in block 706, the process 700 continues by storing the application process data within a centralized database. This allows for the deployment of the data at a separate channel for user completion of the application, use of the data in a separate application, or the like. In this way, if the user continues the application from a different channel, the data will still be stored and available for the user in the new channel format. Furthermore, if the user desires to start a different application, the system may prepopulate the application with data stored from the previous application the user filled in. Thus providing a streamlined application processing network for omni-channel utilization.

As illustrated in block 708, the process 700 continues by generating a confidence level analysis for the user. This confidence level analysis is based on the user data within the platform. The data may include application data the user may have inputted during the onboarding, information about the user's current products and interactions with the entity, and the like. The confidence score may be used to trigger real-time distribution of resources upon a future application filing, as illustrated in block 710. In this way, the user, based on the confidence level scoring, may receive resources in real-time without any processing or review delays.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function. As such, once the software and/or hardware of the claimed invention is implemented the computer device and application-specific circuits associated therewith are deemed specialized computer devices capable of improving technology associated with the in authorization and instant integration of a new credit card to digital wallets.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a special purpose computer for the authorization and instant integration of credit cards to a digital wallet, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein

What is claimed is:

1. A system for providing a digital onboarding and real-time dispersion display interface, the system comprising:
a memory device with computer-readable program code stored thereon;
a communication device;
a processing device operatively coupled to the memory device and the communication device, wherein the processing device is configured to execute the computer-readable program code to:
create a communicable linkage between communication channels across an entity for communication identification;
identify a user communication via one of the communication channel;
onboard the user digitally across platform, where onboarding the user digitally across the platform comprises storing application process data associated with user communication;
modify text within a website based on onboarding the user digitally across the platform;
generate a confidence level analysis that the stored application processing data associated with the user communication is current; and
provide cross channel application processing with population of application processing data associated with the user communication at a different channel.

2. The system of claim 1, wherein onboarding the user digitally across platforms further comprises performing onboarding platform metrics on the user communication to identify products and services associated with the user.

3. The system of claim 2, further comprising generating a compatibility score correspond to the products and services provided, wherein the compatibility score is calculated based on a match between the products and services provided and terms the user utilized during the communication providing a predictive user interested in the products and services for future user implementation.

4. The system of claim 3, further comprising presenting an associate communicating with the user with a real-time presentment of options or adjustments to the user for the products and services provided and the score associated therewith for presentation to the user during communication with the user.

5. The system of claim 1, wherein modifying text within a website based on onboarding the user digitally across the platform further comprises modify words on the website for the user based on engine identified trending search terms for the user, wherein the modifying is performed via integration within a current application program interfaces to dynamically change the websites for the user.

6. The system of claim 1, further comprising triggering a real-time distribution of resources upon a future application filing based on the stored application process data and the confidence level of the stored application process data, such that upon completion of the application and the application filing the user receive resources in real-time without additional processing delays.

7. The system of claim 1, wherein modifying text within a website based on onboarding the user digitally across the platform further comprises tailoring the text within the website for the user.

8. A computer program product for providing a digital onboarding and real-time dispersion display interface n, the computer program product comprising at least one non-transitory computer-readable medium having computer-readable program code portions embodied therein, the computer-readable program code portions comprising:
an executable portion configured for creating a communicable linkage between communication channels across an entity for communication identification;
an executable portion configured for identifying a user communication via one of the communication channel;
an executable portion configured for onboarding the user digitally across platform, where onboarding the user digitally across the platform comprises storing application process data associated with user communication;
an executable portion configured for modifying text within a website based on onboarding the user digitally across the platform;
an executable portion configured for generating a confidence level analysis that the stored application processing data associated with the user communication is current; and
an executable portion configured for providing cross channel application processing with population of application processing data associated with the user communication at a different channel.

9. The computer program product of claim 8, wherein onboarding the user digitally across platforms further comprises performing onboarding platform metrics on the user communication to identify products and services associated with the user.

10. The computer program product of claim 9, further comprising an executable portion configured for generating a compatibility score correspond to the products and services provided, wherein the compatibility score is calculated based on a match between the products and services provided and terms the user utilized during the communication providing a predictive user interested in the products and services for future user implementation.

11. The computer program product of claim 10, further comprising an executable portion configured for presenting an associate communicating with the user with a real-time presentment of options or adjustments to the user for the products and services provided and the score associated therewith for presentation to the user during communication with the user.

12. The computer program product of claim 8, wherein modifying text within a website based on onboarding the user digitally across the platform further comprises modify words on the website for the user based on engine identified trending search terms for the user, wherein the modifying is performed via integration within a current application program interfaces to dynamically change the websites for the user.

13. The computer program product of claim 8, further comprising an executable portion configured for triggering a real-time distribution of resources upon a future application filing based on the stored application process data and the confidence level of the stored application process data, such that upon completion of the application and the application filing the user receive resources in real-time without additional processing delays.

14. The computer program product of claim 8, wherein modifying text within a website based on onboarding the user digitally across the platform further comprises tailoring the text within the website for the user.

15. A computer-implemented method for providing a digital onboarding and real-time dispersion display interface, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
creating a communicable linkage between communication channels across an entity for communication identification;
identifying a user communication via one of the communication channel;
onboarding the user digitally across platform, where onboarding the user digitally across the platform comprises storing application process data associated with user communication;
modifying text within a website based on onboarding the user digitally across the platform;
generating a confidence level analysis that the stored application processing data associated with the user communication is current; and
providing cross channel application processing with population of application processing data associated with the user communication at a different channel.

16. The computer-implemented method of claim 15, wherein onboarding the user digitally across platforms further comprises performing onboarding platform metrics on the user communication to identify products and services associated with the user.

17. The computer-implemented method of claim 16, further comprising generating a compatibility score correspond to the products and services provided, wherein the compatibility score is calculated based on a match between the products and services provided and terms the user utilized during the communication providing a predictive user interested in the products and services for future user implementation.

18. The computer-implemented method of claim 17, further comprising presenting an associate communicating with the user with a real-time presentment of options or adjustments to the user for the products and services provided and the score associated therewith for presentation to the user during communication with the user.

19. The computer-implemented method of claim 15, wherein modifying text within a website based on onboarding the user digitally across the platform further comprises modify words on the website for the user based on engine identified trending search terms for the user, wherein the modifying is performed via integration within a current application program interfaces to dynamically change the websites for the user.

20. The computer-implemented method of claim 15, further comprising triggering a real-time distribution of resources upon a future application filing based on the stored application process data and the confidence level of the stored application process data, such that upon completion of the application and the application filing the user receive resources in real-time without additional processing delays.
